(19) United States
(12) Patent Application Publication
(10) Pub. No.: US 2010/0046736 A1
(43) Pub. Date: Feb. 25, 2010

(54) VOICE COMMUNICATION SYSTEM, EQUIPMENT AND PROGRAM

(75) Inventors: Ryuta ASHIMI, Kawasaki (JP); Kiyotaka IMAGAWA, Yokohama (JP); Hirofumi KAWASE, Tokyo (JP)

Correspondence Address: MATTINGLY & MALUR, P.C., 1800 DIAGONAL ROAD, SUITE 370, ALEXANDRIA, VA, 22314, US

(73) Assignee: HITACHI, LTD., Tokyo (JP)

(21) Appl. No.: 12/488,906

(22) Filed: Jun. 22, 2009

(30) Foreign Application Priority Data
Aug. 21, 2008 (JP) 2008-212368

(51) Int. Cl. H04M 3/00; G06F 1/00

(52) U.S. Cl. 379/350; 713/310; 713/323

(57) ABSTRACT

A telephone list data table on an IP telephone server is provided with a region for memorizing a power saving mode state of a PC to be mounted with each softphone. Still more, in the case where there is a calling request of a softphone, a power saving mode of a PC mounted with a softphone is confirmed, and in the case of being in a power saving mode, an IP telephone server transmits a message to return from the power saving mode, to the PC. Still more, after returning of the PC from the power saving mode, calling of the softphone is performed.

### INCORPORATION BY REFERENCE

The present application claims priority from Japanese application JP 2008-212368 filed on Aug. 21, 2008, the content of which is hereby incorporated by reference into this application.

### BACKGROUND OF THE INVENTION

The present invention relates to a system for calling an IP telephone on a PC in a power saving state in an IP telephone system, an equipment and a program.

In the case where IP telephone software called a softphone is used in an IP telephone system, the softphone is used by installing onto a PC. In addition, a PC is provided with a power saving mode for suppressing a power consumption, therefore, is provided with function automatically shifting to a power saving mode, in the case where the PC is not operated for a long time. “The power saving mode” is a function for automatically shifting to a power saving state, in the case where the PC does not receive an input of operation for a certain period of time, and is very effective for suppression of power consumption, and thus is a function used widely.

As an example of the power saving mode, there is a method for suppression of power consumption by making a power source of a hard disk or other devices off. However, power is supplied to a memory so as to maintain a data in operation as it is, therefore, unlike the case of complete cut off of a power source, it is possible to return to work from a work interruption state. In addition to the above, there is a method for making a power source of each device including the memory off, after transferring the memory contents onto a hard disc.

In JP-A-11-110089, there has been disclosed a method for returning to a normal power source state, on receiving a packet, in a stand-by state of low power consumption, by assignment of an extension number to a PC on a computer network, and in utilization as an extension telephone.

### SUMMARY OF THE INVENTION

In related art, it is possible to recover a PC power source in a stand-by state, however, it requires a special function to a network interface, which cannot utilize an existing PC impossible, and raises a problem of increase in production cost or procurement cost.

Alternatively, even when a “WAKE ON LAN® function” mounted onto an existing network interface is utilized, without using a special network interface, because a terminal at a sending side does not know that a terminal at a receiving side is in a stand-by state, it transmits a call connection request as usual, without starting the terminal at a receiving side, using the “WAKE ON LAN® function”. Because a call connection server does not know also that the terminal at a receiving side is in a stand-by state, it transmits the call connection request as usual, without starting the terminal at a receiving side, using the “WAKE ON LAN® function”, therefore a correct call connection is not possible.

In order to solve the above problems, it is an object of the present invention to attain a system, which performs a calling of a softphone after automatic return from a power saving state, by providing a telephone list data table on an IP telephone server with a region for memorizing a power saving mode state of a PC to be mounted with each softphone, an equipment or a program.

According to the present invention, in the case where a softphone is utilized while utilizing an automatic shift function to a power saving mode, it is possible to receive a telephone even in the case where a PC shifted to the power saving mode.

Other objects, features and advantages of the invention will become apparent from the following description of the embodiments of the invention taken in conjunction with the accompanying drawings.

### BRIEF DESCRIPTION OF THE DRAWINGS

FIG. 1 shows one example of a system outline.

FIG. 2 shows one example of a telephone list data table.

FIG. 3 shows one example of a data sequence on shifting to a power saving mode of a PC.

FIG. 4 shows one example of a data sequence on calling of a softphone of a PC in a power saving mode.

FIG. 5 shows one example of an operation flow chart of an IP telephone server on calling of a softphone.

FIG. 6 shows one example of a hardware configuration of an IP telephone server.

FIG. 7 shows one example of a hardware configuration of a terminal equipment having telephone function.

FIG. 8 shows one example of a system outline using a wireless communication.

### DETAILED DESCRIPTION OF THE INVENTION

Explanation will be given in more detail below on embodiments of the present invention, with reference to drawings.

### Embodiment 1

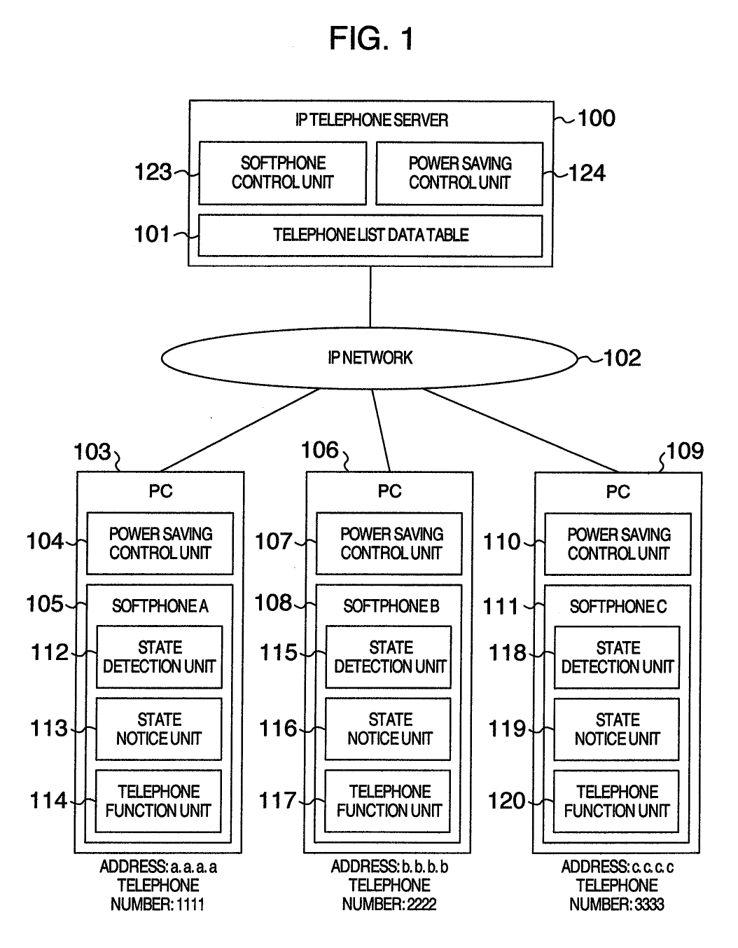

FIG. 1 shows an outline of a system, where the present embodiment was applied. The present system is configured by an IP telephone server 100 for controlling a softphone and a state information of a PC installed with the softphone, a PC103 installed with a softphone A105, a PC106 installed with a softphone B108, a PC109 installed with a softphone C111, and an IP network 102 for connecting the IP telephone server 100 with each PC.

The IP telephone server 100 has a softphone control unit 123 controlling a softphone and performing a control such as a call control as the IP telephone server, and a power saving control unit 124 for controlling whether a PC installed with each softphone is in a power saving mode or not, and performs an exchange of a control signal with each PC. In addition, it also has a telephone list data table 101 for controlling a correspondence between a telephone number of each softphone and an IP address, and whether a PC installed with each softphone is in power saving state or not.

The PC103 has a power saving control unit 104 for performing a shift to a power saving mode and a return from the power saving mode of the PC, besides the softphone A105. PC106 and PC109 similarly have a power saving control unit 107 and a power saving control unit 110, respectively. In addition, the softphone A105 has a state detection unit 112 for detecting that the PC103 has returned from the power saving mode, a state notice unit 113 performing a notice etc. of state information to the IP telephone server 100, and a telephone function unit 114 provided with a function for operating as a telephone, such as a call connection request or a receiving response, communication function as a telephone. The softphone B108 and the softphone C111 also have the similar configuration.

In the present embodiment, a telephone number “1111” shall be given to the softphone A105, and the IP address “a. a. a. a.” shall be assigned to the PC103 installed with the softphone A105. Similarly, a telephone number “2222” shall be given to the softphone B108, and the IP address “b. b. b. b.” shall be assigned to the PC106 installed with the softphone B108. A telephone number “3333” shall be given to the softphone C111, and the IP address “c. c. c. c.” shall be assigned to the PC109 installed with the softphone C111. Only one IP address shall be assigned to the PC in the present embodiment, and the assigned IP address shall be, as it is, an IP address of a softphone corresponding to the telephone number of the softphone.

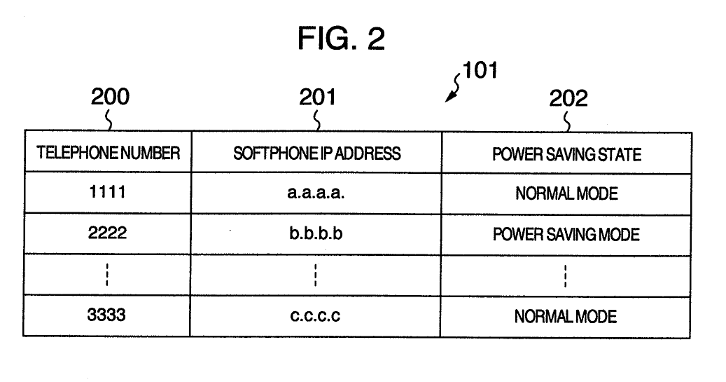

FIG. 2 is a configuration of the telephone list data table 101 to be controlled in the IP telephone server 100. The telephone list data table 101 has a telephone number 200 of each softphone, an IP address 201 of each softphone corresponding to the telephone number 200, and a power saving state 202 showing whether a PC installed with the softphone of the telephone number 200 is in a power saving state or not. In the power saving state 202, there is stored an information of either “a power saving mode” showing that a PC is in a power saving state, or “a normal mode” showing that a PC is not in a power saving state but is normally working. In the present embodiment, in the telephone list data table 101, there are stored the telephone number 200 of the softphone A105, the softphone B108 and the softphone C111, and the softphone IP address 201 of the softphone corresponding to the telephone number 200 of each softphone. In the case where each softphone performs a registration processing as an IP telephone into the IP telephone server 100, the telephone number 200 and the softphone IP address 201 are written in the telephone list data table 101. In an initial state, as for all of the power saving states 202, “normal modes” are written in showing that a PC is working as usual. It should be noted that the telephone list data table 101 may add the attribution for memorizing a state of a telephone terminal under control, in a table for memorizing a correspondence between a telephone of an existing SIP server and an IP address, or may be prepared as a new table.

Next, explanation will be given on operation of a telephone call from the softphone A105 installed onto the PC103 to the softphone B108 installed onto the PC106, in the case where there is no input of processing for a certain period of time to the PC106, or the PC106 is shifted to a power saving mode by intentional operation of a user to shift the PC106 to a power saving mode.

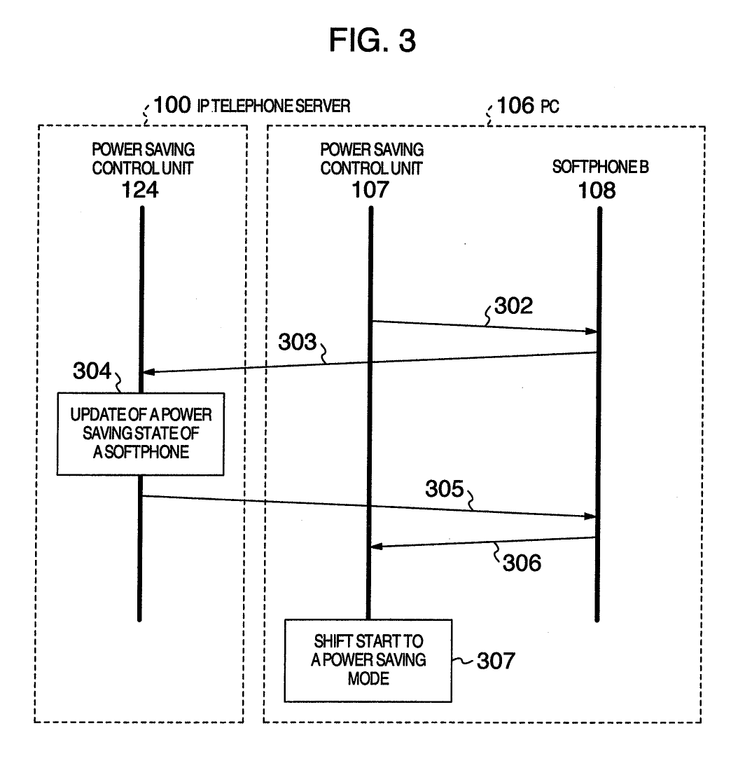

First, FIG. 3 shows the operation in the case where the PC 106 installed with the softphone B108 shifts to a power saving mode. In the case where the PC 106 shifts to a power saving mode, the power saving control unit 107 of the PC106 transmits a shift confirmation to a power saving mode, to the softphone B108, which is an application operating on the PC106 (302). The softphone B108, which received the shift confirmation to a power saving mode via the state notice unit 113, transmits a shift notice to a power saving mode to the power saving control unit 124 inside the IP telephone server 100, via the state notice unit 113 (303). The power saving control unit 124, which received the shift notice to a power saving mode, rewrites the power saving state 202 of a record corresponding to the softphone B108 of the telephone list data table 101, from “a normal mode” to “a power saving mode”. After that, the power saving control unit 124 transmits a shift acceptance to a power saving mode (305). The softphone B108, which received the shift acceptance to a power saving mode via the state notice unit 113, transmits a shift approval to a power saving mode to the power saving control unit 107, via the state notice unit 113 (306). The power saving control unit 107, which received the shift approval to a power saving mode, allows the PC 106 to shift to a power saving mode (307) at this point of time.

Conventionally, in the case where a PC shifts to a power saving mode, an equipment or software corresponding to the power saving control unit 107 notices the shift to the power saving mode, to an application in running. A PC shifts to a power saving mode on receiving the reply to the shift to the power saving mode, from the application. On the contrary, in the present embodiment, the softphone, on receiving the notice of the shift confirmation to a power saving mode, notices that the PC will shift to the power saving mode from now to the IP telephone server 100, and then issues the shift approval to the power saving mode to the power saving control unit 113. In this way, the IP telephone server 100 is always capable of controlling whether a PC installed with a softphone under control is in a power saving state or not.

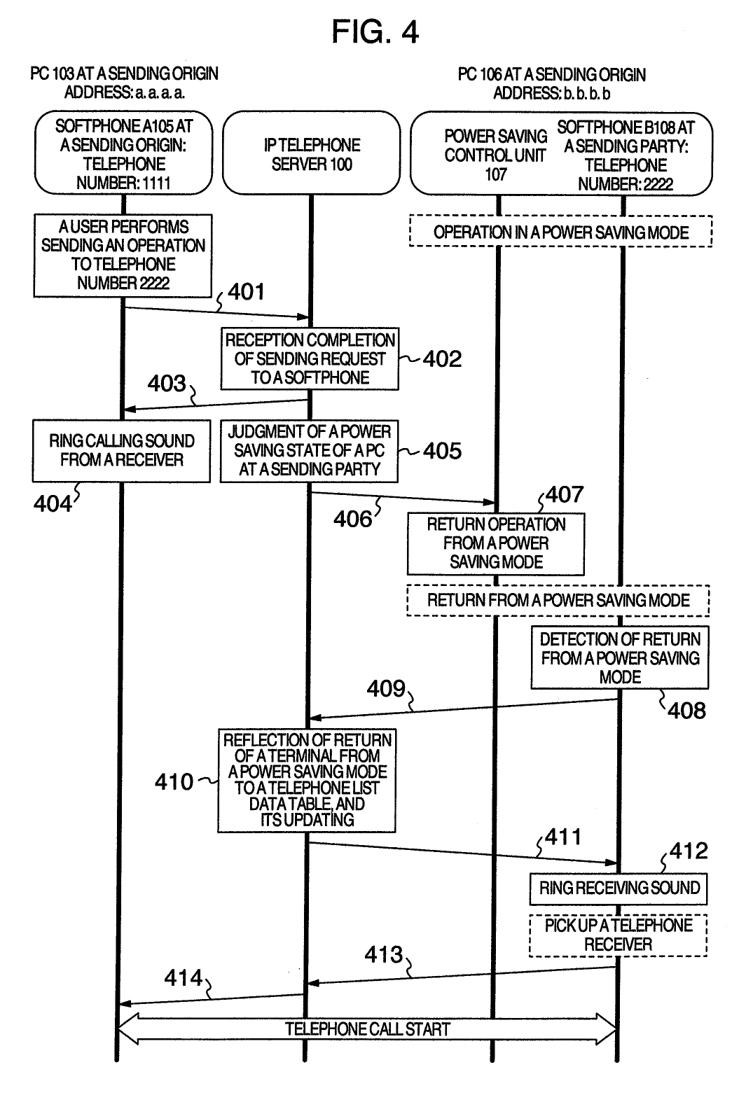

FIG. 4 shows the operation on performing a call connection from the softphone A105 to the softphone B108 on the PC106 in a power saving mode. Explanation will be given later on detailed processing of each softphone or the IP telephone server 100. The softphone A105 transmits a sending request to the telephone number “2222” of the softphone B108, which is an intended party, to the IP telephone server 100 via a telephone function unit 114 (401). The IP telephone server 100, upon completion of receiving the sending request to the softphone B108 (402), notices that the softphone B108 is in a calling state to the softphone A105 (403). The softphone A105, which received a message of the step (403) via the telephone function unit 114, rings calling sound from a receiver (404).

Next, the IP telephone server 100 judges a power saving state (405) of the PC 106 of a sending party. As in FIG. 2, because the softphone B108 is in “a power saving mode”, the IP telephone server 100 transmits a return request from a power saving mode to the PC106 installed with the softphone B108 (406). This return request may be performed, for example, by using “WAKE ON LAN® function”. The PC 106, which received a message of the step (406) via the state notice unit 113, performs the return processing from a power saving mode by the power saving control unit 107 to shift to a normal mode (407).

When the PC 106 recovers from a power saving mode and shifts to a normal mode, the softphone B108 detects the return from a power saving mode by a state detection unit 118 (408). Then, the softphone B108 transmits a return notice from a power saving mode to the IP telephone server 100 via a state notice unit 119 (409). The IP telephone server 100, which received the return notice from a power saving mode, rewrites the power saving state 202 of a record corresponding to the softphone B108 of the telephone list data table 101, from “a power saving mode” to “a normal mode” (410). Then, the IP telephone server 100 transmits a calling notice to a sending request of the step (401), to the softphone B108 (411). The calling notice of the step (411) includes IP address “a. a. a. a.” of the sending origin. The softphone B108, on receiving the calling notice by a telephone function unit 120, rings receiving sound to notice that a telephone call request was present to a user (412).

Next, in the case where a user took an action to respond to a telephone call such as picking up a receiver, a response notice is transmitted from the softphone B108 to the IP telephone server 100 via the telephone function unit 120 (413). The IP telephone server 100, which received the response notice, transmits the response notice to the softphone A105, which is a sending origin (414). The response notice of the step (414) includes the IP address “b. b. b. b.” of the sending party. The softphone A105, which received the response notice, starts a telephone call with the softphone B108.

It should be noted that, also in the case where the softphone B108, which is a terminal at a receiving side, returns from a power saving mode by an operation etc. of a user before incoming call, a return notice from a power saving mode is transmitted to the IP telephone server 100 via the state notice unit 119, similarly as in the step (409).

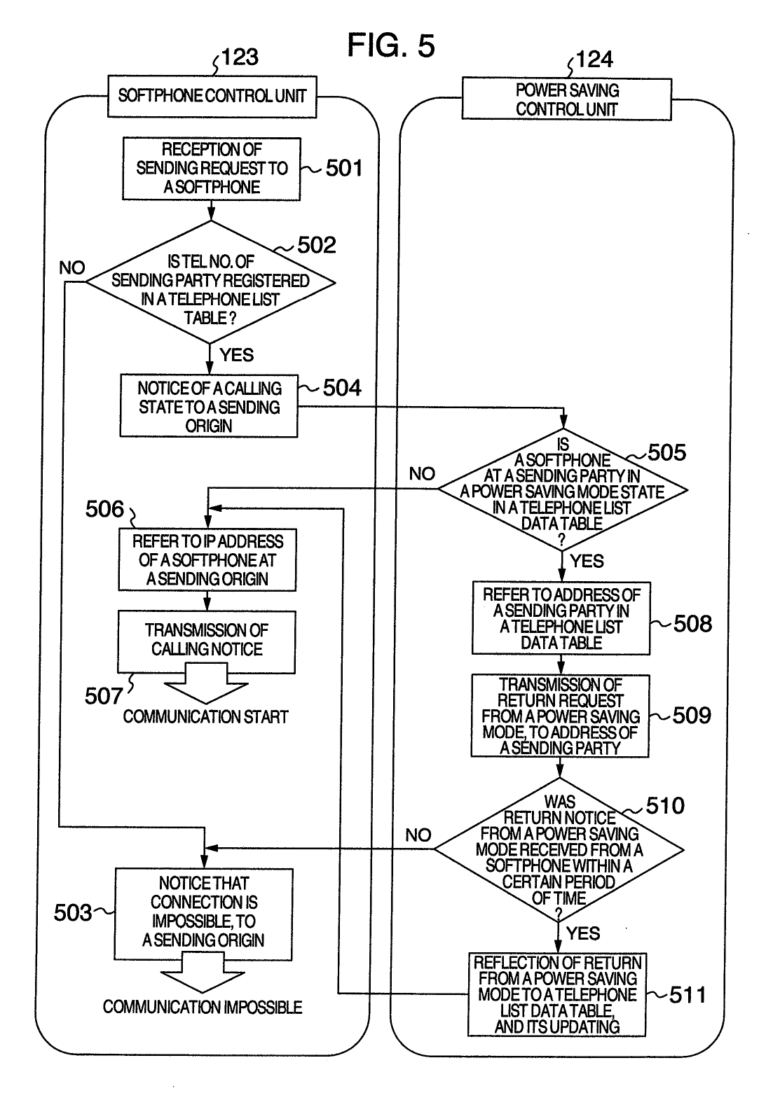

FIG. 5 shows a flow chart of the case where the IP telephone server 100 receives a calling request to the softphone B108 installed onto the PC 106 in a power saving mode explained in FIG. 4. A softphone control unit 123 of the IP telephone server 100 receives a sending request from the softphone A105 to the telephone number “2222” of the softphone B108 (501). The softphone control unit 123, which received the sending request, confirms whether the telephone number “2222” of the sending party is registered or not in the telephone list data table 101 (502). If in the case where the telephone number “2222” is not registered in the telephone list data table 101, the softphone control unit 123 notices that connection is impossible to the softphone A105, which is a sending origin (503).

In the present embodiment, telephone number “2222” is registered in the telephone list data table 101, and the softphone control unit 123 notice that the softphone B108, which is a sending party, is now being called, to the softphone A105, which is a sending origin (504). Then, the power saving control unit 124 confirms whether the softphone B108, which is a sending party, is in a power saving state or not in the telephone list data table 101 (505). In the case where the softphone B108, which is a sending party, is in “a normal state”, the softphone control unit 123 refers to the IP address “b. b. b. b.” corresponding to the telephone number “2222” of the softphone B108, which is a sending party, in the telephone list data table 101 (506), and transmits a calling notice to the softphone B108 (507).

In the case where the softphone B108, which is a sending party, is in “a power saving mode”, the power saving control unit 124 refers to the IP address “b. b. b. b.” corresponding to the telephone number “2222” of the softphone B108, which is a sending party (508), and transmits a return request from a power saving mode to the IP address “b. b. b. b.”, which is a sending party (509). After the step (509), for a certain period of time, the power saving control unit 124 receives a message of the return notice from a power saving mode from the softphone B108, which is a sending party (510). In the case where the power saving control unit 124 did not receive the return notice from a power saving mode, the softphone control unit 123 notices that connection is impossible to the softphone A105, which is a sending origin (503). In the case where the power saving control unit 124 received the return notice from a power saving mode, the power saving state 202 of a record corresponding to the IP address “b. b. b. b.” of the telephone list data table 101, is updated to “a normal mode” (511). Until processing of the step (511) is performed, a sending request to the telephone number “2222” of the softphone B108 is held by the IP telephone server 100, and not transferred to the softphone B108.

After the softphone B108, which is a sending party, is updated to “a normal mode” in the step (511), the softphone control unit 123 refers to the IP address “b. b. b. b.” corresponding to the telephone number “2222” of the softphone B108, which is a sending party, by the telephone list data table 101 (506), and transmits a calling notice (507) to the softphone B108.

### Embodiment 2

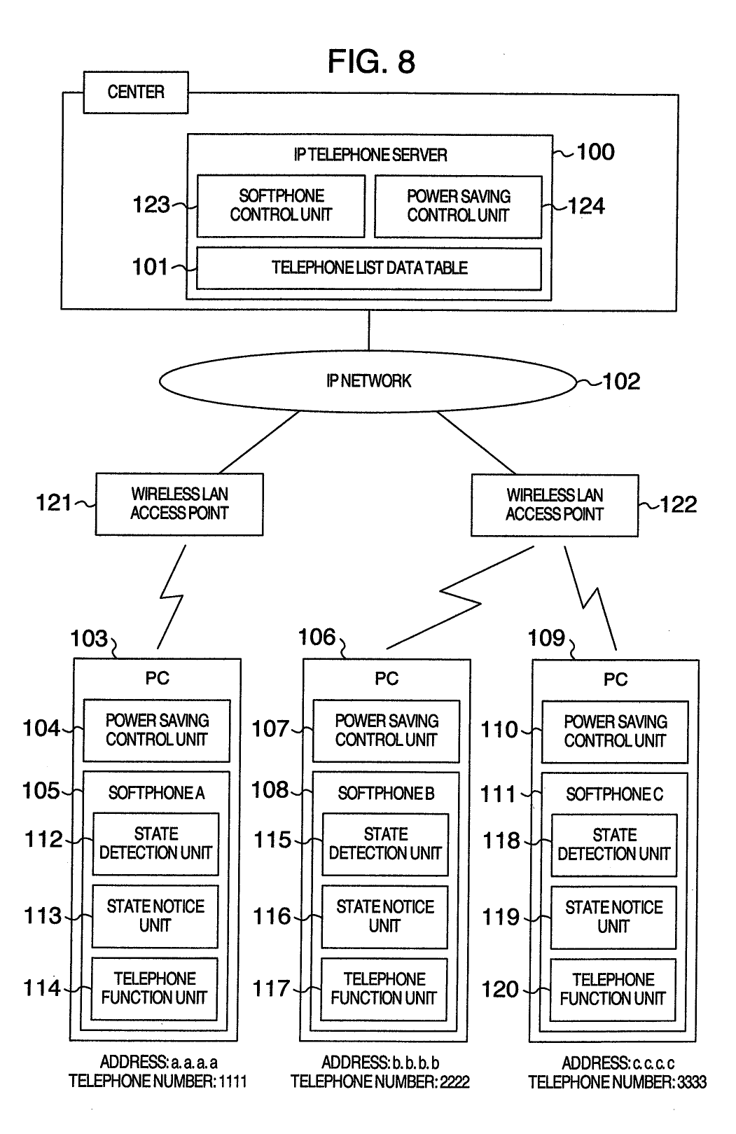

FIG. 8 shows the second outline in a system, where the present Embodiment was applied. In the present system, as the different points from FIG. 1, each of PC103, PC106 and PC109 is connected with the IP telephone server 100 via wireless LAN access points 121 and 122. In the present system, explanation will be given on utilization under the wireless LAN environment such as FIG. 8. PC 103, PC106 and PC109 are supposed to be mobile terminals such as a notebook-type PC or a PDA terminal.

In the case where the PC103 enters inside a communication area of the wireless LAN access point 121, the telephone function unit 114 of the softphone A105 performs the registration processing by an SIP protocol to the softphone control unit 123 inside the IP telephone server 100 via the wireless LAN access point 121. At this point of time, a record of the softphone A105 is formed in the telephone list data table 101. Next, in the case where the PC103 does not receive any operation input for a certain period of time and shifts to a power saving mode, it is noticed to the IP telephone server 100 that the softphone A105 was shifted to a power saving mode, by a similar procedure as in Embodiment 1. Next, in the case where there was a sending request from the softphone B108 of the PC 106, which is present inside the communication area of the wireless LAN access point 122, to the softphone A105, the IP telephone server 100 allows the PC 103 to recover from a power saving mode by a procedure shown in FIG. 4, and performs a calling notice to the softphone A105. The softphone A105, which received the calling notice, transmits a response notice to the softphone B108 via the IP telephone server 100, and telephone call becomes possible hereafter.

In the case where the PC 103 comes out from the communication area of the wireless LAN access point 121, and enters the communication area of the wireless LAN access point 122, the telephone function unit 114 of the softphone A105 performs a registration processing by the SIP protocol to the softphone control unit 123 inside the IP telephone server 100 via the wireless LAN access point 122. As the registration processing, there is considered, for example, rewriting of a record of the softphone A105 of the telephone list data table 101, or deletion of an old record of the softphone A105 with regenerating newly a record of the softphone A105 in the telephone list data table 101, etc.

Next, in the case where the PC 103 shifts to a power saving mode without receiving any operation input for a certain period of time, it is noticed that the softphone A105 shifted to a power saving mode to the IP telephone server 100 by a similar procedure as in Embodiment 1. Next, in the case where there was a sending request from the softphone B108 of the PC 106, which is present inside the communication area of the wireless LAN access point 122, to the softphone A105, the IP telephone server 100 recovers the PC 103 from a power saving mode by a similar procedure shown in FIG. 4, and performs a calling notice to the softphone A105. The softphone A105, which received the calling notice, transmits a response notice to the softphone B108 via the IP telephone server 100, and telephone call becomes possible hereafter.

In this way, by performing a registration processing and a state notice of a telephone by each destination, under wireless LAN environment too, receiving of a message in a power saving state becomes possible. The system of the present embodiment can adapt to not only a free address office but also public wireless LAN environment.

In Embodiments 1 and 2, in the steps (405, 406) of FIG. 4, the IP telephone server confirms that a softphone of a receiving side is in a power saving mode, and on confirmation that it is the power saving mode, transmits a return request from the power saving mode. As an alternative method, in the case when the sending request of the step (401) comes, the calling notice may be transmitted, always after transmitting the return request from a power saving mode without performing the judgment of a power saving state of the softphone of a receiving side.

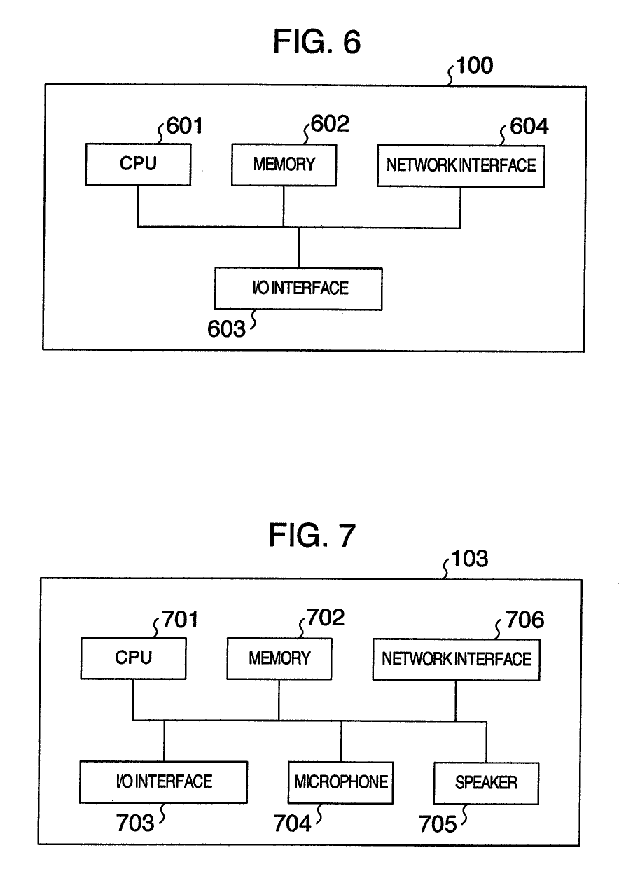

Then, FIG. 6 shows a hardware configuration of the IP telephone server 100 explained in Embodiments 1 and 2. An IP telephone server is configured by a CPU 601, a memory 602, an I/O interface 603 and a network interface 604. The softphone control unit 123, the power saving control unit 124 and the telephone list data table 101 of FIG. 1 are stored in the memory 602. The CPU 601 refers to the softphone control unit 123 stored in the memory 602, the power saving control unit 124 and the telephone list data table 101, and perform the processing explained in the present Embodiment. In addition, in the case where the IP telephone server 100 communicates with the PC 103, the PC 106 and the PC 109, the network interface 604 is used. The I/O interface 603 is used for input and output using a keyboard or a display etc.

Then, FIG. 7 shows a hardware configuration of the PC103 installed with a softphone. The PC 106 and the PC 109 have the same configuration. The PC 103 is configured by a CPU 701, a memory 702, an I/O interface 703, a microphone 704, a speaker 705 and a network interface 706. The power saving control unit 104 and the softphone A105 are mounted as software, and stored in the memory 702. The CPU 701 performs software of the softphone A105 together with the power saving control unit 104 stored in the memory 702, to perform processing explained in Embodiments 1 and 2. In addition, in the case where voice input from a user is received as a telephone, the microphone 704 is utilized. In the case where voice is output to a user, the speaker 705 is used. The microphone 704 and the speaker 705 may be built-in or external. In the case where the PC 103 communicates with the IP telephone server 100, the network interface 706 is used. The I/O interface 703 is used for input and output using a keyboard or a display or the like.

According to a form of the above Embodiments 1 and 2, in the case where a PC shifts to a power saving mode, by noticing that the softphone shifts to a power saving mode, to an IP telephone server, it becomes possible for the IP telephone server to always grasp a state of the PC where the softphone is installed. In this way, on call connection, before transferring the call connection request of a terminal equipment at a sending side, the IP telephone server becomes possible to do the telephone call with returning the PC, which is installed with the softphone at a sending party, from a power saving mode, after returning the PC, which installed the softphone of a terminal equipment at a receiving side, to a normal mode, and confirming that it can receive the call connection request. The above processing is applicable to an overall terminal equipment, which is provided with telephone function for performing the call connection request to a telephone server and can talk on the phone with other terminal equipment.

It should be noted that the IP telephone server explained in Embodiments 1 and 2 has a function to perform a call connection processing of a softphone, and may also be expressed as a voice communication server, or a communication server. In addition, the power saving control unit controls an operation mode of a PC, and may also be expressed as an operation mode control unit. In addition, the softphone control unit is capable of performing call connection processing of not only a softphone but also a telephone terminal to be connected to an IP network, and thus may also be expressed as a communication function control unit or a call connection control unit. In addition, the telephone list data table is not necessary a table, and may be the memory unit for memorizing correspondence among a telephone number of a softphone, an IP address of a softphone, and a power saving state.

It should be further understood by those skilled in the art that although the foregoing description has been made on embodiments of the invention, the invention is not limited thereto and various changes and modifications may be made without departing from the spirit of the invention and the scope of the appended claims.

1. A voice communication server connected to a terminal equipment, which is provided with call function and operates in two operation modes of a power saving mode for suppressing a power consumption and a normal mode, by a communication network, comprising:
an operation mode control unit for transmitting a message for returning to a normal mode, to a terminal equipment at a receiving side, on receiving a sending request to the terminal equipment at a receiving side during operation in the power saving mode from a terminal equipment at a sending side; and
a call function control unit for transmitting a calling notice to the terminal equipment at a receiving side, on receiving a message to notify a return to the normal mode, from the terminal equipment at a receiving side.

2. The voice communication server according to claim 1, further comprising:
a communication address for specifying the terminal equipment in the communication network; and a memory unit for memorizing an operation mode of the terminal equipment shown by the communication address.

3. The voice communication server according to claim 2, wherein
the call function control unit retrieves whether the communication address for specifying the terminal equipment at a receiving side is registered in the memory unit or not, on receiving a call connection request from the terminal equipment at a sending side,
in the case where the communication address of the terminal at a receiving side was registered, above communication function control unit refers to the operation mode of the terminal equipment at a receiving side corresponding to the communication address of the terminal at a receiving side of the memory unit by the operation mode control unit, and in the case where the operation mode of the terminal equipment of the memory unit is a power saving mode, above communication function control unit transmits a message for returning to a normal mode to the terminal equipment at a receiving side.

4. The voice communication server according to claim 3, Wherein the operation mode control unit changes an operation mode of the terminal equipment of the memory unit to a normal mode, on receiving a message to notify the return to a normal mode from the terminal equipment at a receiving side.

5. The voice communication server according to claim 3, wherein the operation mode control unit updates an operation mode of the terminal equipment of the memory unit to a power saving mode, on receiving a shift notice to a power saving mode from the terminal equipment.

6. A terminal equipment, which is provided with call function and operates in two operation modes of a power saving mode for suppressing a power consumption and a normal mode, comprising:
a power saving control unit for shifting to a power saving mode, in the case of no input from a user for a certain period of time; and
a voice communication unit for notifying a shift to a power saving mode to a voice communication server, on shifting to the power saving mode.

7. The terminal equipment according to claim 6,
Wherein characterized in THAT, in the case of receiving a receiving notice during operation in a power saving mode, the terminal equipment receives a message for directing a return from a power saving mode from the voice communication server by the voice communication unit, transmits a message for notifying a return from the power saving mode to the voice communication server, and receives the receiving notice.

8. The terminal equipment according to claim 7, wherein the communication address of the terminal equipment at a sending side is included in the receiving notice.

9. A program for allowing a terminal equipment, which is provided with call function and operates in two operation modes of a power saving mode for suppressing a power consumption and a normal mode, to function as
a unit for shifting to a power saving mode, in the case of no input from a user for a certain period of time; and
a unit for notifying shift to a power saving mode to the voice communication server, on shifting to the power saving mode.

10. The program according to claim 9, wherein the program is allowed to function as
a unit for receiving a message for directing return from a power saving mode from the voice communication server by the voice communication unit, in the case of receiving a receiving notice during operation in a power saving mode,
a unit for transmitting a message for notifying a return from the power saving mode to the voice communication server,
and a unit for receiving the receiving notice.

11. The program according to claim 10, wherein communication address of the terminal equipment at a sending side is included in the receiving notice.

12. A voice communication system, comprising:
a terminal equipment, which is provided with call function and operates in two operation modes of a power saving mode for suppressing a power consumption and a normal mode, having a power saving control unit for shifting to a power saving mode, in the case of no input from a user for a certain period of time, and a voice communication unit for notifying a shift to a power saving mode to a voice communication server, on shifting to the power saving mode; and a voice communication server characterized by comprising an operation mode control unit for transmitting a message for returning to a normal mode, to a terminal equipment at a receiving side, in the case where the terminal equipment at a receiving side is in a power saving mode, on receiving a call connection request to the terminal equipment at a receiving side during operation in the power saving mode from a terminal equipment at a sending side, and a call function control unit for transmitting a calling notice to the terminal equipment at a receiving side, on receiving a message to notify a return to the normal mode, from the terminal equipment at a receiving side.

13. The voice communication system according to claim 12, wherein the voice communication server comprises:
a communication address for specifying the terminal equipment in the communication network, and
a memory unit for memorizing an operation mode of the terminal equipment shown by the communication address.

14. The voice communication system according to claim 13, wherein,
the voice communication server retrieves whether the communication address for specifying the terminal equipment at a receiving side is registered in the memory unit or not, on receiving a call connection request from the terminal equipment at a sending side, by the call function control unit,
in the case where the communication address of the terminal at a receiving side was registered, above communication function control unit refers to the operation mode of the terminal equipment at a receiving side corresponding to the communication address of the terminal at a receiving side of the memory unit by the operation mode control unit, and in the case where the operation mode of the terminal equipment of the memory unit is a power saving mode, above communication function control unit transmits a message for returning to a normal mode to the terminal equipment at a receiving side.

15. The voice communication system according to claim 14, wherein the voice communication server changes an operation mode of the terminal equipment of the memory unit to a normal mode, on receiving a message to notify the return to a normal mode from the terminal equipment at a receiving side by the operation mode control unit.

16. The voice communication system according to claim 13, wherein the voice communication server updates an operation mode of the terminal equipment of the memory unit to a power saving mode, on receiving a shift notice to a power saving mode from the terminal equipment by the operation mode control unit.

17. The voice communication system according to claim 12, wherein, the terminal equipment, in the case of receiving a receiving notice during operation in a power saving mode, receives a message for directing a return from a power saving mode from the voice communication server by the voice communication unit, transmits a message for notifying a return from the power saving mode to the voice communication server, and receives the receiving notice.

18. The voice communication system according to claim 17, wherein the communication address of the terminal equipment at a sending side is included in the receiving notice.
